(19) United States
(12) Patent Application Publication
(10) Pub. No.: US 2011/0068983 A1
(43) Pub. Date: Mar. 24, 2011

(54) MULTI-FREQUENCY ANTENNA

(75) Inventors: Eiji Koide, Takahama-shi (JP); Rikuo Hatano, Toyota-shi (JP)

(73) Assignee: AISIN SEIKI KABUSHIKI KAISHA, Kariya-shi (JP)

(21) Appl. No.: 12/884,543

(22) Filed: Sep. 17, 2010

(30) Foreign Application Priority Data
Sep. 18, 2009 (JP) 2009-216924

(51) Int. Cl. H01Q 1/38

(52) U.S. Cl. 343/700 MS

(57) ABSTRACT

A multi-frequency antenna includes a ground conductor portion, a first radiation conductor portion serving as a first radiation element facing the ground conductor portion keeping a predetermined distance therefrom, a short circuit portion connecting an end portion of the first radiation conductor portion and the ground conductor portion, and a planar shaped second radiation conductor portion serving as a second radiation element and having a frequency characteristic different from the first radiation element, the second radiation conductor portion having a first end connected to the first radiation conductor portion and a second end connected to a feeding device.

### CROSS REFERENCE TO RELATED APPLICATIONS

This application is based on and claims priority under 35 U.S.C. §119 to Japanese Patent Application 2009-216924, filed on Sep. 18, 2009, the entire content of which is incorporated herein by reference.

### TECHNICAL FIELD

This disclosure relates to a multi-frequency antenna.

### BACKGROUND DISCUSSION

A known multi-frequency antenna is disclosed in JP2001-144524A (hereinafter referred to as Patent reference 1). According to the disclosure of Patent reference 1, one or more of additional conductors having an open end are connected to a perpendicular conductor of a known inverted F antenna. The additional conductor, an L-shaped conductor which constructs the inverted F antenna, and a portion of the perpendicular conductor structure an excitation element, and another excitation element is structured with the additional conductor, the L-shaped conductor, and a portion of the perpendicular conductor. Further, according to the disclosure in Patent reference 1, power is supplied via a matching circuit connected to an end portion of the perpendicular conductor. With the constructions of the multi-frequency antenna disclosed in Patent reference 1, the matching circuit is formed on a printed circuit board arranged on a grounding conductor in order to match an output of power and an input of an antenna. The matching circuit complicates the structure of the feeding portion.

JP2000-68736A (hereinafter referred to as Patent reference 2) discloses a multi-frequency antenna producing equal to or more than three frequencies. The multi-frequency antenna disclosed in Patent reference 2 includes a grounding conductor plate and a radiation conductor plate which face each other keeping a predetermined distance from each other, a short-circuit plate connecting the grounding conductor plate and the radiation conductor plate, and a coaxial feed line feeding power to the radiation conductor plate. The radiation conductor plate disclosed in Patent reference 2 includes three unit radiation conductor plates having different lengths from one another. That is, the disclosure of Patent reference 2 intends to provide the multi-frequency antenna which operates with three frequencies by adopting constructions in which the radiation conductor of the inverted F antenna is formed broader so as to be arranged in parallel to the grounding conductor, and open ends of the radiation conductor form slits and lengths of elements of the unit radiation conductor plates are varied. However, because the downsized multi-frequency antenna disclosed in Patent reference 2 is three-dimensionally constructed, an installing dimension is greater compared to a general inverted F antenna with single frequency, and thus the downsizing is difficult.

A need thus exists for a multi-frequency antenna which is not susceptible to the drawback mentioned above.

### SUMMARY

In light of the foregoing, the disclosure provides a multi-frequency antenna, which includes a ground conductor portion, a first radiation conductor portion serving as a first radiation element facing the ground conductor portion keeping a predetermined distance therefrom, a short circuit portion connecting an end portion of the first radiation conductor portion and the ground conductor portion, and a planar shaped second radiation conductor portion serving as a second radiation element and having a frequency characteristic different from the first radiation element, the second radiation conductor portion having a first end connected to the first radiation conductor portion and a second end connected to a feeding means.

According to another aspect of the disclosure, a multi-frequency antenna includes a ground conductor portion, a first radiation conductor portion serving as a first radiation element facing the ground conductor portion keeping a predetermined distance therefrom, a short circuit portion connecting an end portion of the first radiation conductor portion and the ground conductor portion, and a planar shaped second radiation conductor portion serving as a second radiation element and having a frequency characteristic different from the first radiation element, the second radiation conductor portion having a first end connected to the first radiation conductor portion and a second end connected to a feeding means, the second radiation conductor portion includes a body portion and a connecting line portion which connects with the first radiation conductor portion. Further, the body portion is formed with a plate having a polygonal cross-section and includes a frequency characteristic higher than the first radiation element as the second radiation element.

According to further aspect of the disclosure, a multi-frequency antenna includes a ground conductor portion, a first radiation conductor portion serving as a first radiation element facing the ground conductor portion keeping a predetermined distance therefrom, a short circuit portion connecting an end portion of the first radiation conductor portion and the ground conductor portion, and a planar shaped second radiation conductor portion serving as a second radiation element and having a frequency characteristic different from the first radiation element, the second radiation conductor portion having a first end connected to the first radiation conductor portion and a second end connected to a feeding means, the second radiation conductor portion includes a body portion and a connecting line portion which connects with the first radiation conductor portion. The body portion is formed with a plate having a polygonal cross-section and includes a frequency characteristic higher than the first radiation element as the second radiation element. The polygonal cross-section of the body portion includes at least one oblique side which inclines relative to an extending direction of the first radiation conductor portion. The polygonal cross-section of the body portion corresponds to a pentagonal cross-section which forms the oblique side by obliquely cutting a corner portion of a rectangular cross-section. The body portion having the pentagonal cross-section includes two sides opposing to the oblique side, one of the two sides is arranged to be in parallel to the first radiation conductor portion and the other of the two sides is arranged to be perpendicular to the first radiation conductor portion. The slit includes a first slit portion extending from the oblique side to be perpendicular to the first radiation conductor portion and a second slit portion extending from an inner end portion of the first slit portion to be parallel to the first radiation conductor portion.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is an explanatory view for a schematic design of a multi-frequency antenna according to the disclosure;

FIG. 2 is a view illustrating a triple frequency antenna applied to the multi-frequency antenna according to a first embodiment of the disclosure;

FIG. 3 is a perspective view where the multi-frequency antenna is applicable to an automobile;

FIG. 4 is a graph showing actually measured data regarding a relationship between a frequency and a voltage standing wave ratio (VSWR);

FIG. 5A shows an actually measured radiation pattern of a main polarized wave at a frequency of 720 MHz of the multi-frequency antenna;

FIG. 5B shows an actually measured radiation pattern the main polarized wave at a frequency of 720 MHz of the multi-frequency antenna;

FIG. 6A shows an actually measured radiation pattern the main polarized wave at a frequency of 2.45 GHz of the multi-frequency antenna;

FIG. 6B shows an actually measured radiation pattern the main polarized wave at a frequency of 2.45 GHz of the multi-frequency antenna;

FIG. 7A shows an actually measured radiation pattern the main polarized wave at a frequency of 5.8 GHz of the multi-frequency antenna;

FIG. 7B shows an actually measured radiation pattern the main polarized wave at a frequency of 5.8 GHz of the multi-frequency antenna;

FIG. 8 is a view showing an application of the multi-frequency antenna to a top portion of a windshield; and

FIG. 9 is a perspective view showing a multi-frequency antenna according to a second embodiment of the disclosure.

### DETAILED DESCRIPTION

Embodiments of the disclosure will be explained with reference to illustrations of drawing figures as follows.

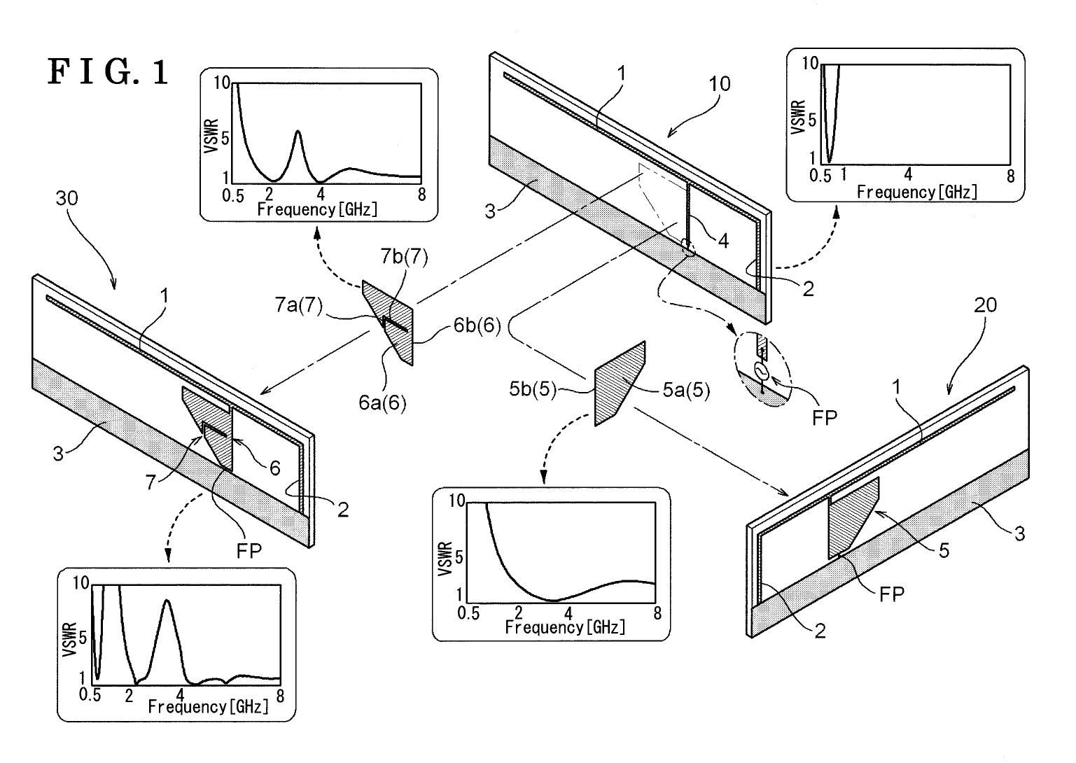

First, referring to FIG. 1, a schematic design of a multi-frequency antenna of the disclosure will be explained. A triple frequency antenna which operates at three separate frequency bands (frequencies) including 720 MHz, 2.45 GHz, and 5.8 GHz will be explained as an example. Basic constructions of the triple frequency antenna correspond to an inverted F antenna structure 10. As illustrated in FIG. 1, the inverted F antenna structure 10 includes a first radiation conductor portion (first radiation conducting portion) 1, a short circuit portion 2, a ground conductor portion 3, a connecting line portion 4, and a feed point FP. The first radiation conductor portion 1 is a linear body which extends in parallel to a linear side of the ground conductor portion 3 having a relatively large dimension, that is, the first radiation conductor portion 1 is arranged keeping a predetermined distance from the ground conductor portion 3. The short circuit portion 2 extends from an end of the first radiation conductor portion 1 perpendicularly to connect to the ground conductor portion 3. The connecting line portion 4 extends from the first radiation conductor portion 1 towards the ground conductor portion 3 at a position being away from the short circuit portion 2 by a distance which is determined so that the first radiation conductor portion 1 functions as a first radiation element for a frequency of 720 MHz. A clearance is provided between the connecting line portion 4 and the ground conductor portion 3, and the feed point FP is provided at the clearance. At the feed point FP, a core wire serving as an inner conductor of a coaxial cable is connected to an end portion of the connecting line portion 4, and a woven or braided wire serving as an outer conductor is connected to the ground conductor portion 3.

The above explained constructions of the inverted F antenna structure 10 are known. As a reference, simulation results of voltage standing wave ratio (VSWR) characteristics relative to frequency when the length of the first radiation conductor portion 1 is determined to be approximately 90 mm, the length of the short circuit portion 2 is determined to be approximately 22 mm, and the distance between the short circuit portion 2 and the connecting line portion 4 is determined to be approximately 25 mm is shown in FIG. 1. Referring to the simulation results, the inverted F antenna structure 10 functions as an antenna at a frequency of 720 MHz (at a frequency centered around 720 MHz).

One of the multi-frequency antennas according to the disclosure is an inverted F antenna-plus-planar antenna structure 20 in which the inverted F antenna structure 10 and a planar antenna structure are combined. The planar antenna structure includes a second radiation conductor portion 5 which is planar. The second radiation conductor portion 5 integrally includes a planar antenna body portion (hereinafter referred to as the body portion) 5a and a connecting line portion 5b connecting the body portion 5a and the first radiation conductor portion 1. The connecting line portion 5b is commonly used as the connecting line portion 4 of the first radiation conductor portion 1, and a feed point FP is formed between an end of the connecting line portion 5b and the ground conductor portion 3. The body portion 5a according to the embodiment includes a pentagonal cross-section which is formed by removing (e.g., cutting) a right triangle including one right angle portion of a square shaped radiation conductor member from the square shaped radiation conductor member. In those circumstances, one of side portions of the body 5a of the second radiation conductor portion 5 serves as the connecting line portion 5b which is commonly used as the connecting line portion 4 of the inverted F antenna structure 10. Further, the body portion 5a is arranged at a position where one of the side portions of the body 5a is positioned keeping a predetermined distance relative to the first radiation conductor portion 1 so that the pentagonal second radiation conductor portion 5 serves as a second radiation element having a frequency characteristic which is different from the first radiation conductor portion 1 serving as the first radiation element (i.e., the second radiation element is configured to send and receive signals at a frequency different from the first radiation conductor portion 1). A configuration dimension of the body portion 5a is determined so that the second radiation conductor portion 5 serves as the second radiation element for a frequency of 5.8 GHz (for a frequency centered around 5.8 GHz).

As a reference, simulation results of voltage standing wave ratio (VSWR) characteristics relative to frequency when the length of two longer sides of the body portion 5a, which extends in parallel to and perpendicular to the first radiation conductor portion 1, of the second radiation conductor portion 5 is determined to be approximately 18 mm, the length of shorter sides, which are shortened in the process of forming a cut oblique side, is determined to be approximately 4 mm is shown in FIG. 1. Referring to the simulation results, the second radiation conductor portion 5 functions as an antenna at a frequency of 5.8 GHz (at a frequency centered around 5.8 GHz).

Accordingly, the inverted F antenna-plus-planar antenna structure 20 formed by combining the first radiation conductor portion 1 and the second radiation conductor portion 5 serves as a multi-frequency antenna which operates at frequencies of 720 MHz and 5.8 GHz (operates at frequencies centered around 720 MHz and 5.8 GHz).

One of multi-frequency antennas of the disclosure is an inverted F antenna-plus-planar antenna with slit structure 30, in which a planar antenna with slit structure is combined with the inverted F antenna structure 10, shown at left bottom in FIG. 1. The planar antenna with slit structure includes a third radiation conductor portion 6 having similar configuration dimension with the second radiation conductor portion 5. The third radiation conductor portion 6 includes a body portion 6a on which a slit 7 extending inward from a side portion is formed. The third radiation conductor portion 6 integrally includes the body portion 6a and a connecting line portion 6b. That is, the third radiation conductor portion 6 corresponds to the second radiation conductor portion 5 of the body portion 5a when the slit 7 is formed thereon. The slit 7 is formed on the body portion 6a of the third radiation conductor portion 6 so that the third radiation conductor portion 6 functions as a third radiation element having a frequency characteristic which is lower than the a frequency characteristic of a radio wave radiated by the second radiation conductor portion 5 serving as the second radiation element and higher than the frequency characteristic of a radio wave radiated by the first radiation conductor portion 1 serving as the first radiation element. According to the embodiment, for example, the slit 7 includes a first slit portion 7a extending perpendicular to the first radiation conductor portion 1 from the oblique side and a second slit portion 7b extending in parallel to the first radiation conductor portion 1 from an end of the first slit 7a positioned at an inward of the body portion 6a.

As a reference, simulation results of voltage standing wave ratio (VSWR) characteristics relative to frequency of the inverted F antenna-plus-planar antenna structure with slit structure 30 when the length of the first slit portion 7a is determined to be approximately 4 mm, the length of the second slit portion 7b is determined to be approximately 8 mm is shown in FIG. 1. Referring to the simulation results, the inverted F antenna structure 10 functions as an antenna at a frequency of 720 MHz. According to the simulation results, the third radiation conductor portion 6, that is, the second radiation conductor portion 5 on which the slit 7 is additionally formed serves as the second radiation element for a frequency of 5.8 GHz and the third radiation element for a frequency of 2.45 GHz. Accordingly, the inverted F antenna-plus-planar antenna structure with slit structure 30 serves as a multi-frequency antenna which operates at a frequency of 720 MHz, 2.45 GHz, and 5.8 GHz (operates at frequency centered around 720 MHz, 2.45 GHz, and 5.8 GHz).

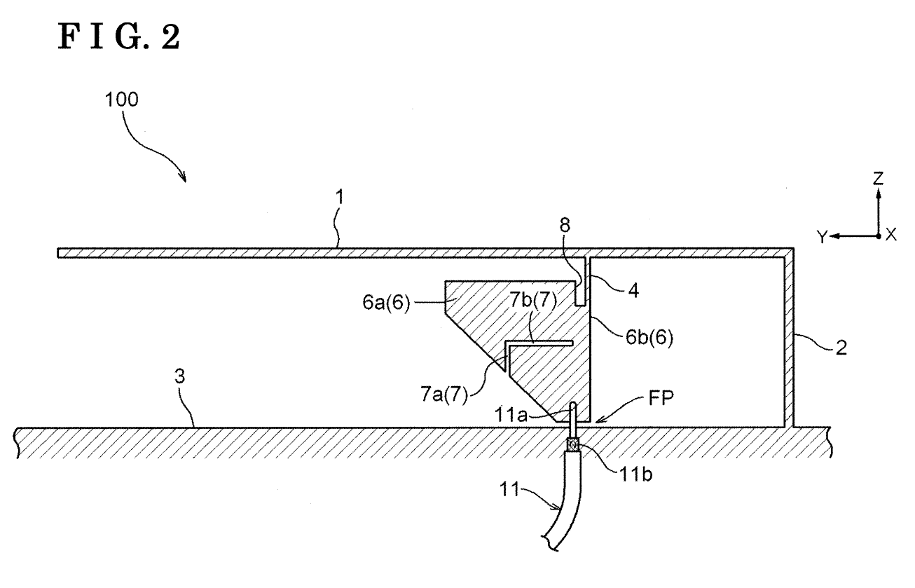

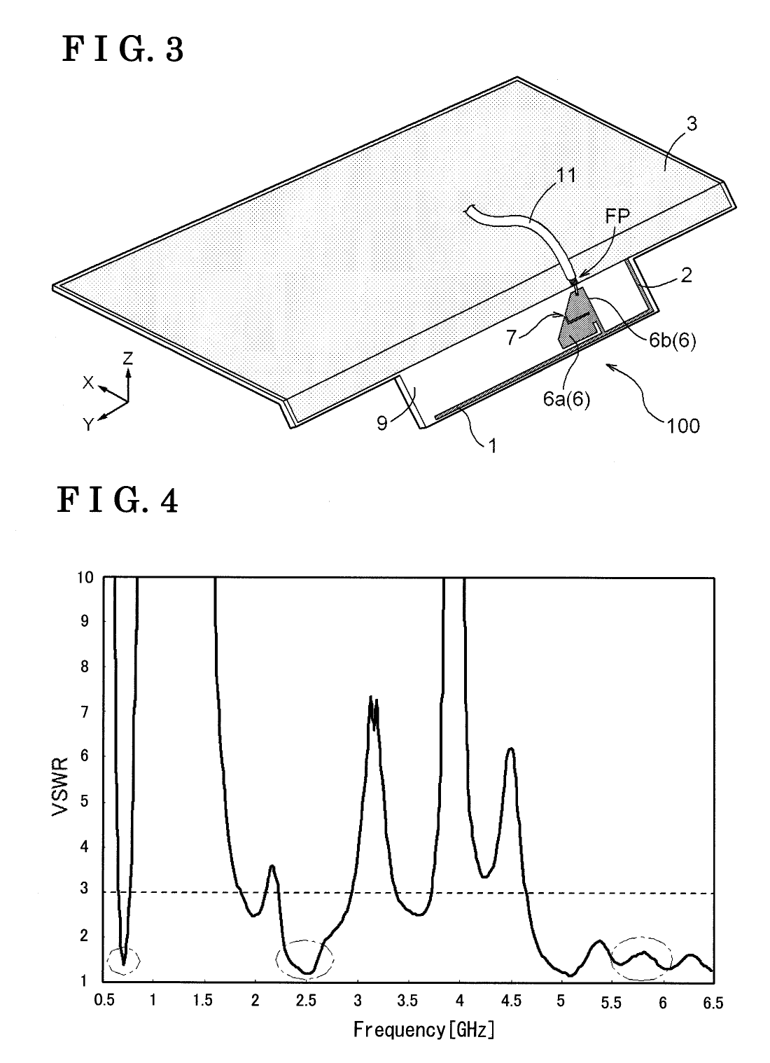

A first embodiment of the multi-frequency antenna will be explained with reference to FIGS. 2 and 3 as follows. FIG. 2 shows a schematic view of a multi-frequency antenna 100. FIG. 3 shows a state where the multi-frequency antenna 100 is mounted to a top portion of a windshield or a rear window of a vehicle.

As illustrated in FIG. 3, the multi-frequency antenna 100 is manufactured by forming copper foil patterns on a glass epoxy board 9 using a printed circuit board manufacturing technique. The multi-frequency antenna 100 corresponds to a triple frequency antenna. Constructions of the triple frequency band antenna 100 is substantially the same with the inverted F antenna-plus-planar antenna with slit structure 30 in FIG. 1. The triple frequency band antenna 100 includes the first radiation conductor portion 1, the short circuit portion 2, the ground conductor portion 3, the third radiation conductor portion 6 which is connected to the first conductor portion 1 via the connecting line portion 4, and the feed point FP. The third radiation conductor portion 6 corresponds to the second radiation conductor portion 5a on which a slit is formed.

The third radiation conductor portion 6 includes the connecting line portion 6b connected to the connecting line portion 4 and the body portion 6a formed in a planar shape and extending continuously from the connecting line portion 6b at a side thereof. The connecting line portion 6b is a part of the body portion 6a. The body portion 5a and the connecting line portion 5b are integrally formed. Further, because the multi-frequency antenna 100 is formed in a form of the copper foil patterns on the glass epoxy board 9, the first radiation conductor portion 1, the short circuit portion 2, the ground conductor portion 3, the connecting line portion 4, and the third radiation conductor portion 6 are integrally formed. As shown in FIG. 2, at the feed point FP, a core wire 11a serving as an inner conductor of a coaxial cable 11 serving as a feeding means is connected to an end portion of the connecting line portion 4, and a woven, or braided wire 11b serving as an outer conductor of the coaxial cable 11 is connected to the ground conductor portion 3.

The body portion 6a including the connecting line portion 6b is configured by removing an isosceles triangle including a right angle portion from a substantial square shaped radiation conductor member. A recess portion 8 is formed at a transitional region between the body portion 6a and the connecting line portion 4 which extends from the first radiation conductor portion 1. The recess portion 8 extends downwardly to define a boundary between a side portion of the body 6a extending in parallel to and facing a longitudinal side of the first radiation conductor portion 1. The recess portion 8 restrains the propagation of the wave of 2.45 GHz and 5.8 GHz, which is excited by the third radiation conductor portion 6, to the first radiation conductor portion 1.

According to the multi-frequency antenna 100 of the embodiment, the length of the first radiation conductor portion 1 is determined to be approximately 90 mm, the length of the short circuit portion 2 is determined to be approximately 22 mm, and the distance between the short circuit portion 2 and the connecting line portion 4 is determined to be approximately 25 mm, which determines the frequency characteristics of the inverted F antenna. The configuration dimension of the body portion 6a which determines frequency characteristics of a high-frequency side of the planar antenna with slit is defined by removing an isosceles right triangle having two sides of 14 mm from an 18 mm-by-18 mm square, the length of an oblique side is 20 mm, and the length of sides which are shortened by forming the oblique side are approximately 4 mm. The configuration of the slit 7 which defines frequency characteristics of the high-frequency side of the planar antenna with slit is defined as follows. That is, the length of the first slit portion 7a, which extends linearly from a middle portion of the oblique side, in other words, extending perpendicular to a longitudinal side of the first radiation conductor portion 1, is approximately 4 mm. Further, the length of the second slit portion 7b, which extends in parallel to the longitudinal side of the first radiation conductor portion 1 from an inner end of the first slit portion 7a forming a right angle therewith, is approximately 8 mm.

As illustrated in FIG. 3, in order to position the multi-frequency antenna 100 at the top portion of the windshield or the rear window of the vehicle by avoiding obstructing the visibility of an occupant, or a driver as much as possible, the main portion of the antenna, including the first radiation conductor portion 1, the short circuit portion 2, and the body portion 6a, may be provided along a surface of the top portion of the windshield or the rear window and a portion of the ground conductor portion 3 which requires a relatively large area may be bent so that most of the bent portion is arranged avoiding obstructing the visibility.

FIG. 4 shows actually measured data of the voltage standing wave ratio (VSWR) characteristics relative to frequency according to the multi-frequency antenna 100 explained above. According to the data, as shown in FIG. 4, the voltage standing wave ratio (VSWR) relative to the frequencies, 720 MHz, 2.45 GHz, and 5.8 GHz, which the multi-frequency antenna 100 is desired to obtain as antenna functions are assumed to be equal to or less than 2.0. Thus, the multi-frequency antenna 100 is applicable at desired frequencies (frequency bands). In those circumstances, according to the actually measured data, shown in FIG. 4, a frequency (frequency band) equal to or greater than 5 GHz shows wideband characteristics.

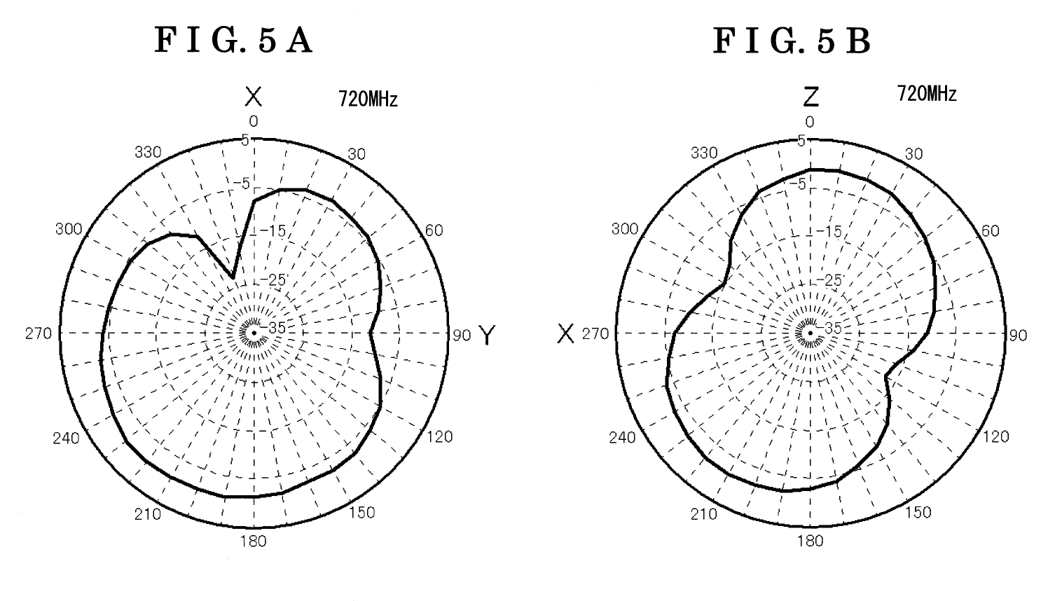

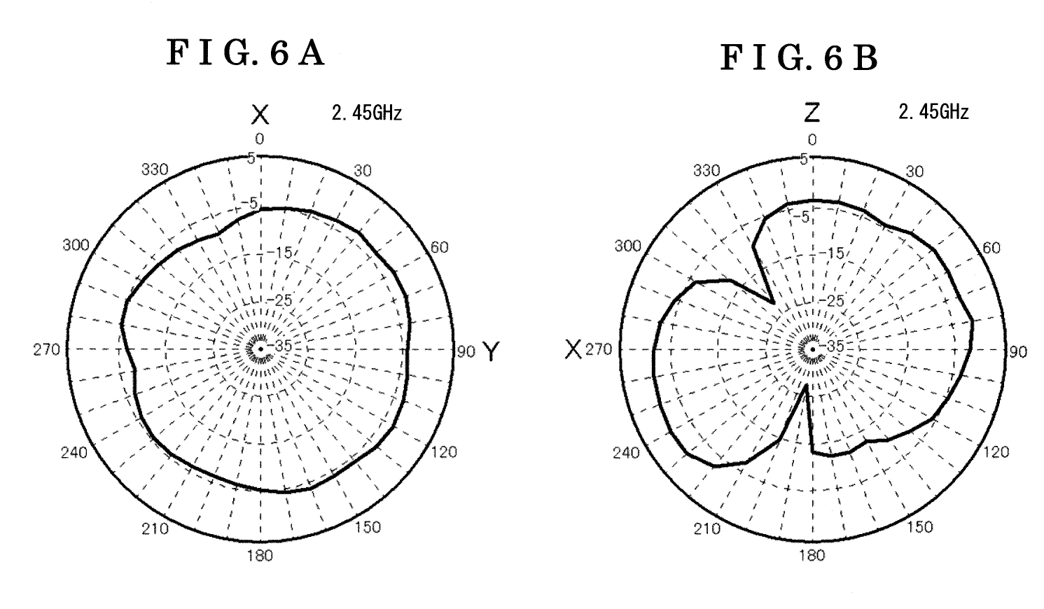

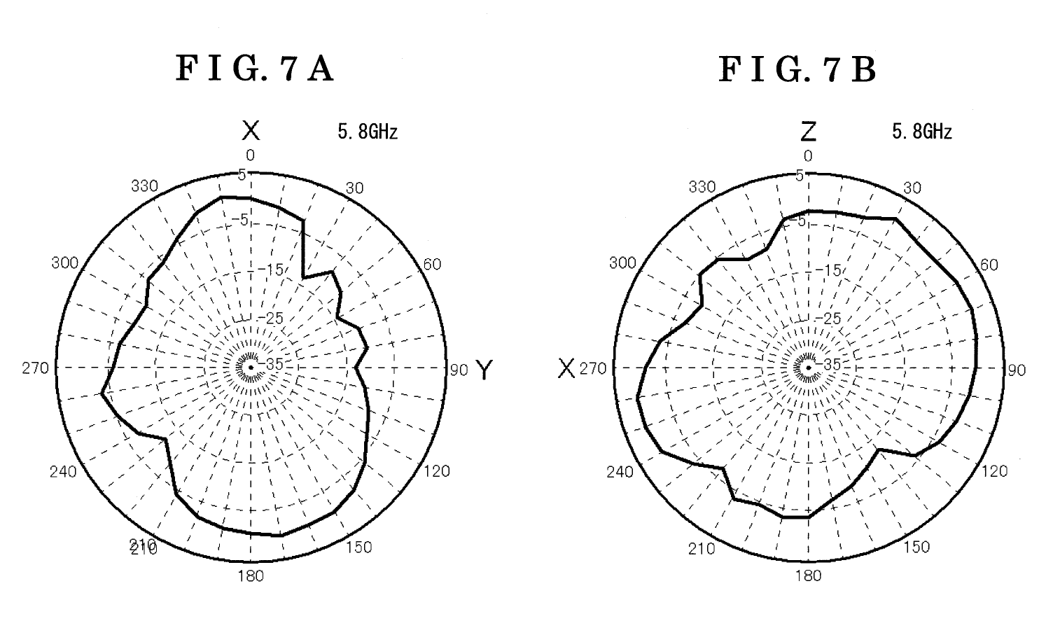

FIGS. 5 to 7 show radiation patterns of an actually measured main polarized wave at the multi-frequency antenna 100. FIG. 5 is a radiation pattern at a frequency of 720 Mhz. FIG. 6 shows a radiation pattern at a frequency of 2.45 GHz. FIG. 7 shows a radiation pattern at a frequency of 5.8 GHz. FIGS. 5A, 6A, and 7A show radiation patterns in an X-Y surface (horizontal surface). FIGS. 5B, 6 B, and 7B show radiation patterns in an X-Z surface (vertical surface).

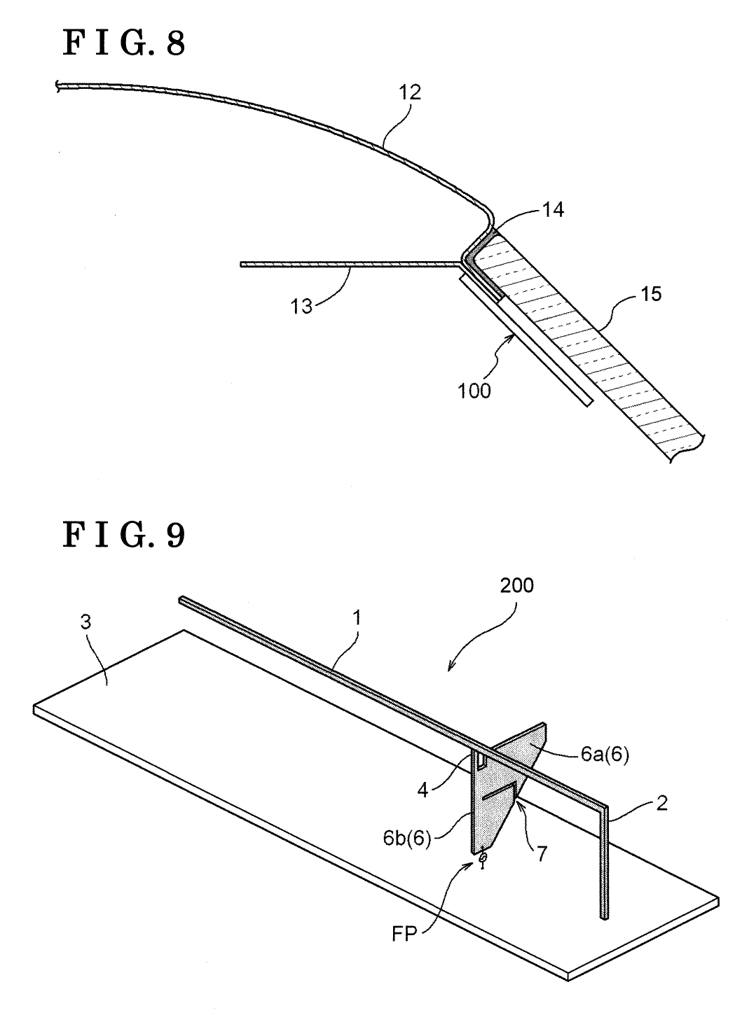

FIG. 8 illustrates an example where the multi-frequency antenna 100 is attached to a region of a windshield 15 of an automobile. The multi-frequency antenna 100 is attached to an inner surface of a bonding region of a roof outer panel 12 and a roof inner panel 13 at which the windshield 15 is fitted via a bonding agent 14. Considering the above-explained radiation patterns, the multi-frequency antenna 100 functions favorably in various directions by mounting the multi-frequency antenna 100 to the automobile in the foregoing manner.

A second embodiment of the multi-frequency antenna will be explained as follows. With the construction of the multi-frequency antenna 100 according to the first embodiment, the first radiation conductor portion 1, the short circuit portion 2, the ground conductor portion 3, the second radiation conductor portion 5, and the third radiation conductor portion 6 are formed as the copper foil patterns on the printed circuit board 9. Instead of forming the elements as the copper foil patterns on the printed circuit board, the elements including the first radiation conductor portion 1, the short circuit portion 2, the ground conductor portion 3, the second radiation conductor portion 5, and the third radiation conductor portion 6 may be formed by mechanical forming such as punching from a conductor plate to assemble a multi-frequency antenna 200. In those circumstances, because each of the elements is made from a metal plate, or the like, each of the elements is independently formed. Accordingly, all of the first radiation conductor portion 1, the short circuit portion 2, the second radiation conductor portion 5, and the third radiation conductor portion 6 may not be formed on the common plane and, for example, the second radiation conductor portion 5 may be arranged to be on a different plane from other elements. For example, FIG. 9 shows a case where a plane on which the first radiation conductor portion 1 and the short circuit portion 2 are formed and a plane on which the second radiation conductor portion 5 and the third radiation conductor portion 6 are formed are arranged perpendicular to each other. Further, according to the first embodiment, the second radiation conductor portion 5 and the third radiation conductor portion 6 are formed in a particular pentagonal shape. However, instead of the particular pentagonal shape, the second radiation conductor portion 5 and the third radiation conductor portion 6 may be formed in another polygonal configuration, such as other pentagonal configuration, or triangular, rectangular, hexagonal configurations, as long as desired frequency characteristics are obtained. In those circumstances, in accordance with the adopted polygonal configurations of the second radiation conductor portion 5 and the third radiation conductor portion 6, configurations of the slit 7 may also be selected. Other constructions of the multi-frequency antenna 200 is the same with the constructions of the first embodiment, and explanations for the same constructions are not repeated.

According to the disclosure of the embodiment, the multi-frequency antenna operates at a first frequency which the first radiation conductor portion 1 as an inverted F antenna radiates or receives and a second frequency which the second radiation conductor portion 5 as a planar antenna radiates or receives. Further, because one end of the second radiation conductor portion 5 is connected to the first radiation conductor portion 1 and another end of the second radiation conductor portion 5 is connected to the coaxial cable (feeding means) 11, power is supplied to the first radiation conductor portion 1 as an element of the inverted F antenna and the second radiation conductor portion 5 as an element of the planar antenna by a single feed point FP. Further, with the construction of the multi-frequency antenna according to the embodiment, because a matching circuit is not required and an unbalanced feeding can be performed, the multi-frequency antenna with a simple structure can be attained.

According to the disclosure of the embodiment, the second radiation conductor portion 5 (6) includes a body portion 5a (6a) and a connecting line portion 5b (6b) which connects with the first radiation conductor portion 1, and the body portion 5a (6a) is formed with a plate having a polygonal cross-section and includes a frequency characteristic higher than the first radiation element 1 as the second radiation element 5 (6). Further, the polygonal cross-section of the body portion 5a (6a) includes at least one oblique side which inclines relative to a longitudinal direction (an extending direction) of the first radiation conductor portion. Still further, the polygonal cross-section of the body portion 5a (6a) corresponds to a pentagonal cross-section which forms the oblique side by obliquely cutting a corner portion of a rectangular cross-section.

According to the embodiment, by selecting appropriate configurations of the body portion 5a (6a), the second radiation conductor portion 5 (6) serving as the planar antenna having higher frequency characteristics than the first radiation conductor portion 1 serving as the inverted F antenna exhibits stable performance. For example, in a case where the pentagonal cross section is adopted, the first radiation element of the first radiation conductor portion 1 may be set to radiate the radio wave at a frequency of 720 MHz which is adopted for an ITS (Intelligent Transport System), or the like, and the second radiation element of the second radiation conductor portion 5 (6) may be set to radiate the radio wave at a frequency of 5.8 GHz, which produces a convenient, or efficient multi-frequency antenna.

According to the disclosure of the embodiment, the body portion 6a of the second radiation conductor portion 6 includes a slit 7 allowing the second radiation conductor portion 6 to serve as a third radiation element which includes a frequency characteristic lower than the second radiation element and higher than the first radiation element.

According to the embodiment, the second radiation conductor portion 5 (6) serves as the second radiation element and the third radiation element which have different frequency characteristics from one another. Thus, according to the embodiment, the multi-frequency antenna which operates at the three frequencies can be attained with a simple structure in which the planar antenna structure is combined with the inverted F antenna.

In order to provide the third radiation element which has lower frequency characteristics than the second radiation element, a slit 7 may be formed on the body portion 5a (6a) so that the second radiation conductor portion 5 (6) serves as the third radiation element having the frequency characteristics which is higher than the first radiation element and lower than the second radiation element.

According to the embodiment, by selecting the appropriate configurations of the slit 7, the second radiation conductor portion 5 (6) also serves as the third radiation element having the higher frequency characteristics than the first radiation element and lower frequency characteristics than the second radiation element. For example, by setting the third radiation element to radiate the radio wave at a frequency of 2.45 GHz which is adopted for a wireless LAN, or the like, the multi-frequency antenna which operates at three frequencies, 720 NHz, 2.45 GHzm and 5.8 GHz can be attained.

According to the disclosure of the embodiment, the body portion 5a (6a) having the pentagonal cross-section includes two sides opposing to the oblique side, one of the two sides is arranged to be in parallel to the first radiation conductor portion 1 and the other of the two sides is arranged to be perpendicular to the first radiation conductor portion 1. The slit includes a first slit portion 7a extending from the oblique side to be perpendicular to the first radiation conductor portion and a second slit portion 7b extending from an inner end portion of the first slit portion 7a to be parallel to the first radiation conductor portion 1.

According to the constructions of the embodiment, the triple frequency antenna which attains excellent measurement results can be obtained. In those circumstances, by positioning the feed point FP with the feeding means in the vicinity of a side which faces the ground conductor portion 3 of the body portion 5a (6a), wiring is smoothly laid out in a case where the feeding means is constructed with the coaxial cable 11.

According to the disclosure of the embodiment, a recess portion 8 is formed at a transitional region between the body portion 5a (6a) and the connecting portion 5b (6b).

According to the construction of the embodiment, because of the recess portion 8, the propagation of the radio wave from the second radiation conductor portion 5 serving either the second radiation element or the third radiation element, or both of the second radiation element and the third radiation element to the first radiation conductor portion 1 serving as the inverted F antenna which radiates the lower frequency than the second radiation conductor portion 5 (6) is restrained.

According to the embodiment, because the first radiation conductor portion 1, the short circuit portion 2, and the second radiation conductor portion 5 are arranged on a common plane, the multi-frequency antenna which is thin and efficient in terms of space can be attained.

According to the embodiment, by constructing the first radiation conductor portion 1, the short circuit portion 2, and the second radiation conductor portion 5 (6) on the same plane, the multi-frequency antenna may be manufactured by a method for producing a conducting layer in which the first radiation conductor portion 1, the short circuit 2, and the second radiation conductor portion 5 (6) are formed on the printed circuit board, or a method for producing integrally formed first radiation conductor portion 1, the short circuit portion 2, and the second radiation conductor portion 5 (6) by punching the thin conductive plate. According to the manufacturing method of printed circuit board, the multi-frequency antenna can be readily mass-produced at a relatively low cost. According to the manufacturing method of stamping, the multi-frequency antenna can be produced at a relatively low cost.

According to the embodiment, for example, the multi-frequency antenna is applied to a vehicle. Because the multi-frequency antenna can be formed with a very thin structure, the first radiation conductor portion 1, the short circuit 2, and the second radiation conductor portion 5 may be mounted along the vehicle window. Accordingly, the surrounding radio wave is assumed to be readily receivable despite the characteristics that the multi-frequency antenna does not stand out and does not obstruct the visibility.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A multi-frequency antenna, comprising:
a ground conductor portion;
a first radiation conductor portion serving as a first radiation element facing the ground conductor portion keeping a predetermined distance therefrom;
a short circuit portion connecting an end portion of the first radiation conductor portion and the ground conductor portion; and
a planar shaped second radiation conductor portion serving as a second radiation element and having a frequency characteristic different from the first radiation element, the second radiation conductor portion having a first end connected to the first radiation conductor portion and a second end connected to a feeding means.

2. A multi-frequency antenna, comprising:
a ground conductor portion;
a first radiation conductor portion serving as a first radiation element facing the ground conductor portion keeping a predetermined distance therefrom;
a short circuit portion connecting an end portion of the first radiation conductor portion and the ground conductor portion; and
a planar shaped second radiation conductor portion serving as a second radiation element and having a frequency characteristic different from the first radiation element, the second radiation conductor portion having a first end connected to the first radiation conductor portion and a second end connected to a feeding means, the second radiation conductor portion includes a body portion and a connecting line portion which connects with the first radiation conductor portion; wherein
the body portion is formed with a plate having a polygonal cross-section and includes a frequency characteristic higher than the first radiation element as the second radiation element.

3. The multi-frequency antenna according to claim 2, wherein the polygonal cross-section of the body portion includes at least one oblique side which inclines relative to an extending direction of the first radiation conductor portion.

4. The multi-frequency antenna according to claim 3, wherein the polygonal cross-section of the body portion corresponds to a pentagonal cross-section which forms the oblique side by obliquely cutting a corner portion of a rectangular cross-section.

5. The multi-frequency antenna according to claim 2, wherein the body portion of the second radiation conductor portion includes a slit allowing the second radiation conductor portion to serve as a third radiation element which includes a frequency characteristic lower than the second radiation element and higher than the first radiation element.

6. The multi-frequency antenna according to claim 4, wherein the body portion of the second radiation conductor portion includes a slit allowing the second radiation conductor portion to serve as a third radiation element which includes a frequency characteristic lower than the second radiation element and higher than the first radiation element.

7. A multi-frequency antenna, comprising:
a ground conductor portion;
a first radiation conductor portion serving as a first radiation element facing the ground conductor portion keeping a predetermined distance therefrom;
a short circuit portion connecting an end portion of the first radiation conductor portion and the ground conductor portion; and
a planar shaped second radiation conductor portion serving as a second radiation element and having a frequency characteristic different from the first radiation element, the second radiation conductor portion having a first end connected to the first radiation conductor portion and a second end connected to a feeding means, the second radiation conductor portion includes a body portion and a connecting line portion which connects with the first radiation conductor portion; wherein
the body portion is formed with a plate having a polygonal cross-section and includes a frequency characteristic higher than the first radiation element as the second radiation element;
the polygonal cross-section of the body portion includes at least one oblique side which inclines relative to an extending direction of the first radiation conductor portion;
the polygonal cross-section of the body portion corresponds to a pentagonal cross-section which forms the oblique side by obliquely cutting a corner portion of a rectangular cross-section;
the body portion having the pentagonal cross-section includes two sides opposing to the oblique side, one of the two sides is arranged to be in parallel to the first radiation conductor portion and the other of the two sides is arranged to be perpendicular to the first radiation conductor portion; and wherein
the slit includes a first slit portion extending from the oblique side to be perpendicular to the first radiation conductor portion and a second slit portion extending from an inner end portion of the first slit portion to be parallel to the first radiation conductor portion.

8. The multi-frequency antenna according to claim 2, wherein a feed point with the feeding means is positioned in the vicinity of a side of the body portion which faces the ground conductor portion.

9. The multi-frequency antenna according to claim 7, wherein a feed point with the feeding means is positioned in the vicinity of a side of the body portion which faces the ground conductor portion.

10. The multi-frequency antenna according to claim 2, further comprising:
a recess portion formed at a transitional region between the body portion and the connecting portion.

11. The multi-frequency antenna according to claim 9, further comprising:
a recess portion formed at a transitional region between the body portion and the connecting portion.

12. The multi-frequency antenna according to claim 1, wherein the first radiation conductor portion, the short circuit, and the second radiation conductor portion are arranged on a common plane.

13. The multi-frequency antenna according to claim 2, wherein the first radiation conductor portion, the short circuit, and the second radiation conductor portion are arranged on a common plane.

14. The multi-frequency antenna according to claim 6, wherein the first radiation conductor portion, the short circuit, and the second radiation conductor portion are arranged on a common plane.

15. The multi-frequency antenna according to claim 7, wherein the first radiation conductor portion, the short circuit, and the second radiation conductor portion are arranged on a common plane.

16. The multi-frequency antenna according to claim 12, wherein the first radiation conductor portion, the short circuit portion, and the second radiation conductor portion are formed on a printed circuit board.

17. The multi-frequency antenna according to claim 12, wherein the first radiation conductor portion, the short circuit portion, and the second radiation conductor portion are formed by punching a conductive plate integrally.

18. The multi-frequency antenna according to claim 1, wherein the first radiation conductor portion, the short circuit portion, and the second radiation conductor portion are mounted along a vehicle window.

19. The multi-frequency antenna according to claim 2, wherein the first radiation conductor portion, the short circuit portion, and the second radiation conductor portion are mounted along a vehicle window.

20. The multi-frequency antenna according to claim 6, wherein the first radiation conductor portion, the short circuit portion, and the second radiation conductor portion are mounted along a vehicle window.
